(19) United States
(12) Patent Application Publication
(10) Pub. No.: US 2010/0121628 A1
(43) Pub. Date: May 13, 2010

(54) INTEGRATED CIRCUIT VERIFICATION DEVICE AND METHOD

(76) Inventor: Heat-Bit PARK, Gyeonggi-do (KR)

Correspondence Address: IP & T Law Firm PLC, 7700 Little River Turnpike, Suite 207, Annandale, VA, 22003, US

(21) Appl. No.: 12/431,905

(22) Filed: Apr. 29, 2009

(30) Foreign Application Priority Data
Nov. 10, 2008 (KR) 10-2008-0111246

(51) Int. Cl. G06F 17/50

(52) U.S. Cl. 703/14

(57) ABSTRACT

An integrated circuit verification device includes a trace-back unit having structure data of an integrated circuit to be verified, and configured to trace back nodes of the integrated circuit in a direction from an output node to an input node; and a state defining unit having data with respect to a target state of the output node of the integrated circuit, and configured to sequentially define states of back-traced nodes to satisfy the target state of the output node.

### CROSS-REFERENCE TO RELATED APPLICATIONS

The present invention claims priority of Korean patent application number 10-2008-0111246, filed on Nov. 10, 2008, disclosure of which is incorporated by reference herein in its entirety.

### BACKGROUND OF THE INVENTION

The present invention relates to an integrated circuit verification device, and more particularly, to an integrated circuit verification device and an integrated circuit verification method, which are used to find out poorly designed points in an integrated circuit.

In general, a simulation is performed to observe and determine circuit characteristics and output waveforms in designing of typical integrated circuits. A header file having a format suitable for each simulator exists to perform the simulation, and a circuit designer should properly define an input state in the header file to obtain an available simulation output waveform. Here, the header file means a file containing information about a device performance, environmental conditions, an input state of the circuit, etc., so as to perform the simulation.

In a conventional simulator, an input state is defined by a circuit designer, and an algorithm obtaining an output waveform according to the input state is then performed.

However, when a circuit requires a number of input signals, it may take a long time to define input states. Furthermore, the input states may be differently defined depending on the skill of a circuit designer and characteristic, thus giving rise to a problem that output waveforms may differ according to the skill of a circuit designer and characteristic.

Moreover, in a case where an output of a circuit does not satisfy a designed value or level expected by a circuit designer, the circuit designer is difficult to find out poorly designed points using a conventional simulation device and method when the circuit is complicatedly designed.

### SUMMARY OF THE INVENTION

Embodiments of the present invention are directed to providing an integrated circuit verification device that can easily and accurately define an input state in a header file for simulation.

Embodiments of the present invention are also directed to providing an integrated circuit verification method that can easily and accurately define an input state in a header file for simulation.

Embodiments of the present invention are also directed to providing an integrated circuit verification device that can easily find out poorly designed points.

Embodiments of the present invention are also directed to providing an integrated circuit verification method that can easily find out poorly designed points.

In accordance with an aspect of the present invention, there is provided an integrated circuit verification device including: a trace-back unit having structure data of an integrated circuit to be verified, and configured to trace back nodes of the integrated circuit in a direction from an output node to an input node; and a state defining unit having data with respect to a target state of the output node of the integrated circuit, and configured to sequentially define states of back-traced nodes to satisfy the target state of the output node.

The trace-back unit may perform a trace-back operation up to the input node by defining an input node of an element having the output node as an output node of another element, and detecting input nodes of next-stage elements connected to said another element.

The integrated circuit verification device may further include a determining unit to determine whether the nodes which may be traced back in sequence by the trace-back unit may be identical to the structure data of the integrated circuit, and may notify to the state defining unit that the back-traced node may be a node of which a state may to be defined when the back-traced nodes may be identical to the structure data of the integrated circuit.

The structure data of the integrated circuit and the data with respect to the target state of the output node may be transferred from the outside.

In accordance with an another aspect of the present invention, there is provided an integrated circuit verification device including: a circuit analyzer having structure data of an integrated circuit to be verified and data with respect to a target state of an output node of the integrated circuit, and configured to perform a trace-back operation in a direction from the output node to an input node and to sequentially define nodes which are detected in sequence by the trace-back operation; and a simulator configured to simulate the integrated circuit using a state value of the input node defined by the circuit analyzer to provide an output of the output node.

The circuit analyzer may include a trace-back unit having the structure data of the integrated circuit, and configured to trace back nodes of the integrated circuit in a direction from the output node to the input node; and a state defining unit having the data with respect to the target state of the output node of the integrated circuit, and configured to sequentially define states of back-traced nodes to satisfy the target state of the output node.

The trace-back unit may perform a trace-back operation up to the input node by defining an input node of an element having the output node as an output node of another element, and detecting input nodes of next-stage elements connected to said another element.

The circuit analyzer may further include a determining unit to determine whether the nodes which may be traced back in sequence by the trace-back unit may be identical to the structure data of the integrated circuit, and may notify to the state defining unit that the back-traced node is a node of which a state may to be defined when the back-traced nodes may be identical to the structure data of the integrated circuit.

The structure data of the integrated circuit and the data with respect to the target state of the output node may be transferred from the outside.

In accordance with an another aspect of the present invention, there is provided an integrated circuit verification device including: a simulator having structure data of an integrated circuit to be verified and initial state data of an input node of the integrated circuit, and configured to define nodes of the integrated circuit by simulating the integrated circuit using the initial state data of the input node; a circuit analyzer having structure data of the integrated circuit and data with respect to a target state of the output node of the integrated circuit, and configured to perform a trace-back operation in a direction from the output node to an input node and to sequentially define nodes which are detected in sequence by the trace-back operation; and a comparator configured to compare states of nodes defined by the circuit analyzer with states of nodes defined by the simulator to output a comparison result.

The circuit analyzer may include a trace-back unit having the structure data of the integrated circuit, and configured to trace back nodes of the integrated circuit in a direction from the output node to the input node; and a state defining unit having the data with respect to the target state of the output node of the integrated circuit, and configured to sequentially define states of back-traced nodes to satisfy the target state of the output node.

The trace-back unit may perform a trace-back operation up to the input node by defining an input node of an element having the output node as an output node of another element, and detecting input nodes of next-stage elements connected to said another element.

The circuit analyzer may further include a determining unit to determine whether the nodes which may be traced back in sequence by the trace-back unit may be identical to the structure data of the integrated circuit, and may notify to the state defining unit that the back-traced node may be a node of which a state may to be defined when the back-traced nodes may be identical to the structure data of the integrated circuit.

The comparator may output state data of the node when a state of the node defined by the circuit analyzer may be not equal to a state of the node defined by the simulator.

The structure data of the integrated circuit and the data with respect to the target state of the output node may be transferred from the outside.

In accordance with an another aspect of the present invention, there is provided an integrated circuit verification method including: receiving structure data of an integrated circuit to be verified and a target state of an output node of the integrated circuit; tracing back elements connected to the output node of the integrated circuit in a direction from the output node to an input node of the integrated circuit, and sequentially defining states of input nodes of back-traced elements to satisfy the target state of the output node; defining a state of the input node of the integrated circuit to satisfy the defined states of the input nodes of the elements by tracing back the input node of the integrated circuit; and outputting the defined state of the input node of the integrated circuit.

The structure data of the integrated circuit may include an input node list of the integrated circuit, an output node list of the integrated circuit, and connection data between elements of the integrated circuit.

The tracing back of the input node of the integrated circuit may include determining whether the input node of the back-traced element may included in the input node list of the integrated circuit; and repeating tracing and determining operations on another element connected to the input node of the element when the input node of the back-traced element may be not included in the input node list of the integrated circuit.

In accordance with an another aspect of the present invention, there is provided an integrated circuit verification method including: receiving structure data of an integrated circuit to be verified, a simulation result of the integrated circuit, and a target state of an output node of the integrated circuit; tracing back elements connected to the output node of the integrated circuit in a direction from the output node to an input node of the integrated circuit, and sequentially defining states of input nodes of back-traced elements to satisfy the target state of the output node; comparing the defined states of the input nodes of the elements with the simulation result, and determining whether the defined states of the input nodes of the elements are identical to the simulation result; and outputting an input node data of the element which is not identical to the simulation result.

The structure data of the integrated circuit may include an input node list of the integrated circuit, an output node list of the integrated circuit, and connection data between elements of the integrated circuit; and the simulation result may include state values of nodes of the integrated circuit which may be outputted after the integrated circuit may be simulated using initial state data of the input node of the integrated circuit.

The determining of whether the defined states of the input nodes of the elements may be identical to the simulation result may be performed by repeating operations of: determining whether the input node of the element may be included in the input node list of the integrated circuit when the state of the input node of the element may be identical to the simulation result; tracing back another element connected to the input node of the element when the input node of the element may be not included in the input node list of the integrated circuit; defining a state of an input node of said another back-traced element to satisfy the state of the input node of the element; and comparing the state of the input node of said another element with the simulation result.

The state of the input node of the element may be outputted when the input node of the back-traced element may be included in the input node list of the integrated circuit.

### BRIEF DESCRIPTION OF THE DRAWINGS

FIG. 1 is a block diagram of an integrated circuit verification device in accordance with the present invention.

FIG. 2 is a flowchart illustrating an integrated circuit verification method in accordance with an embodiment of the present invention.

FIG. 3 is a flowchart illustrating an integrated circuit verification method in accordance with another embodiment of the present invention.

FIG. 4 is a circuit diagram illustrating an integrated circuit verification method in accordance with the present invention.

### DESCRIPTION OF SPECIFIC EMBODIMENTS

Other objects and advantages of the present invention can be understood by the following description, and become apparent with reference to the embodiments of the present invention.

The present invention provides an integrated circuit verification device and an integrated circuit verification method, which define states of nodes by tracing back the nodes to satisfy a state of an output node pre-defined by a circuit designer in a direction from the output node to an input node.

Prior to the description for embodiments of the present invention, ‘input node of an integrated circuit’ described herein means a ‘node to which an input signal is inputted in the integrated circuit, the input signal is a signal inputted from the outside to an inside of the integrated circuit, here, and ‘output node of the integrated circuit’ means a ‘node through which an output signal is outputted in the integrated circuit, the output signal is a signal outputted from the inside to the outside of the integrated circuit, here. In addition, ‘input point of an element’ means an ‘input node connected to an element in the integrated circuit’, and ‘output point of an element’ means an ‘output node connected to an element in the integrated circuit’.

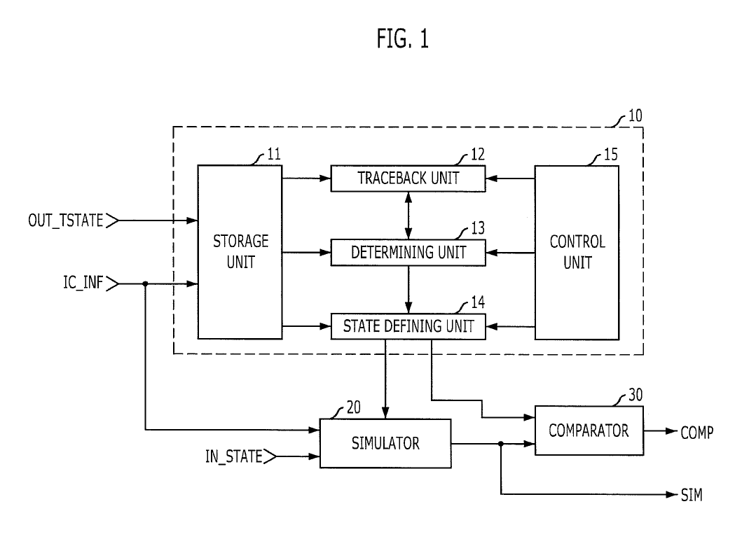

To be specific, referring to FIG. 1, an integrated circuit verification device in accordance with an embodiment of the present invention includes a circuit analyzer 10 and a simulator 20, and may further include a comparator 30.

The circuit analyzer 10 traces back connection nodes from an output node of an integrated circuit to an input node, and defines states of back-traced nodes.

The circuit analyzer 10 may include a storage unit 11, a trace-back unit 12, a determining unit 13, a state defining unit 14, and a control unit 15.

The storage unit 11 stores structure data IC_INF of the integrated circuit that needs to be verified, and a target state OUT_TSTATE of an output node of the integrated circuit for example, state data of the output node defined by a circuit designer. The structure data IC_INF may contain an input node list, an output node list, elements connected between the input node and the output node, data about connections between the elements, and the like.

The trace-back unit 12 traces back connection elements and connection nodes in a direction from the output node of the integrated circuit and the input node using the stored structure data IC_INF. In particular, the trace-back unit 12 traces back input nodes of the integrated circuit in such a sequence that an element connected to the output node of the integrated circuit is traced back first, and then another element connected to an input point of the element is traced back.

The determining unit 13 determines whether the input points of the elements traced back by the trace-back unit 12 are identical to the structure data IC_INF stored in the storage unit 11.

The state defining unit 14 defines states of the nodes determined by the determining unit 13 so as to satisfy the target state OUT_TSTATE of the output node which is stored in the storage unit 11. Particularly, the state defining unit 14 sequentially defines states of the input points of the element determined by the determining unit 13 to thereby define state of the input node of the integrated circuit finally.

The control unit 15 controls the trace-back operation of the trace-back unit 12, the determining operation of the determining unit 13, and the state-defining operation of the state defining unit 14, respectively.

The simulator 20 simulates the integrated circuit based on the structure data IC_INF and then outputs a simulation result SIM. Herein, the simulator 20 may simulate the integrated circuit with a header file containing an arbitrary input node state data IN_STATE, this header file is referred to as ‘initial header file’, hereinafter, or may simulate the integrated circuit with a header file updated to the input node state defined by the circuit analyzer 10. The simulation result SIM of the simulator 20 may include state data of all nodes in the integrated circuit.

The comparator 30 compares the node state of the integrated circuit defined by the circuit analyzer 10 with the simulation result SIM achieved by the initial header file of the simulator 20, thereby outputting a comparison result COMP.

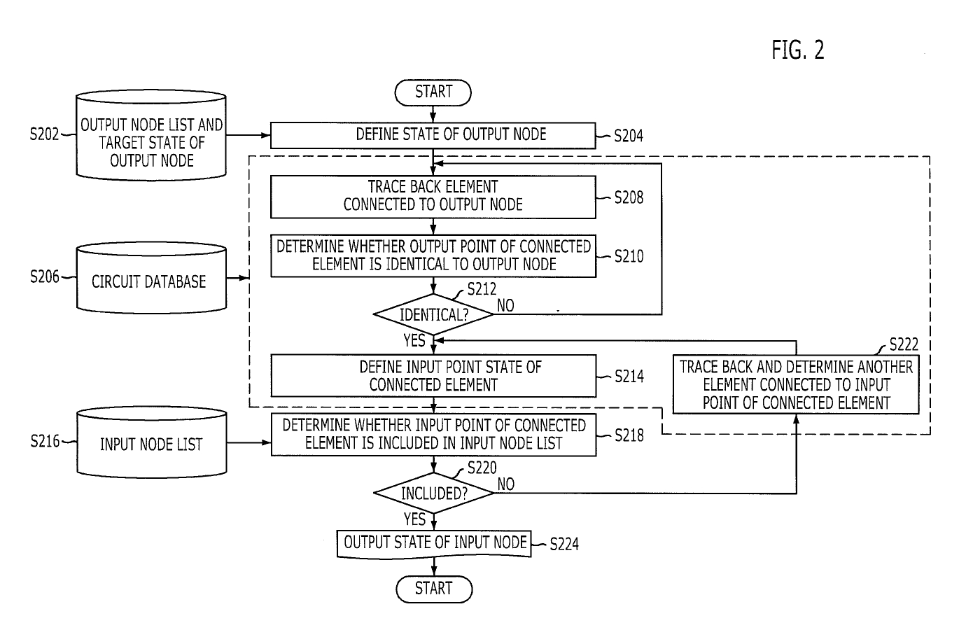

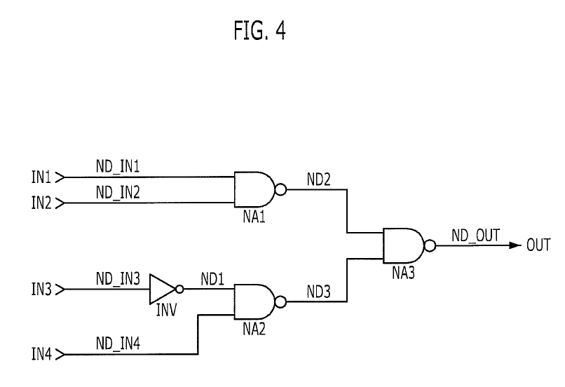

The integrated circuit verification device having the configuration of FIG. 1 may operate in accordance with an embodiment of the present invention in FIG. 2. In particular, the operation of the circuit verification device in accordance with this embodiment of FIG. 2 will be described below when a circuit to be verified has the configuration of FIG. 4.

First, the storage unit 11 stores the structure data of the integrated circuit and the target state of the output node. Referring to FIG. 4, reference symbols ‘IN1 to IN4’ denote input signals inputted to the circuit, and reference symbols ‘ND_IN1 to ND_IN4’ denote an input node list. Furthermore, symbols ‘OUT’ and ‘ND_OUT’ denote an output signal outputted from the circuit and an output node list, respectively.

At step S202, the output node list ND_OUT and the target state of the output node, which are stored in the storage unit 11, are inputted. Then, at step S204, a state of the output node is defined. Herebelow, it is assumed that the target state of the output node ND_OUT is a logic high level.

After the state of the output node ND_OUT is defined, a circuit database stored in the storage unit 11 is inputted at step S206, and then an element connected to the output node ND_OUT among elements NA1, NA2, NA3 and INV is traced back at step S208.

At step S210, it is determined whether the output point of the back-traced element is identical to the output node ND_OUT. When the output point of the back-traced element is not identical to the output node ND_OUT at step S212, an element connected to the output node ND_OUT is traced back again at step S208.

When the output point of the back-traced element is identical to the output node ND_OUT at step S212, that is, when the back-traced element is a NAND gate NA3, states of input points ND2 and ND3 of the NAND gate NA3 are defined so as to satisfy the state of the output node ND_OUT at step S214. Since the output node ND_OUT is in logic high level, the states of the input points ND2 and ND3 of the NAND gate NA3 are defined as logic low level, respectively.

The input node lists ND_IN1 to ND_IN4 stored in the storage unit 11 is inputted at step S216, and it is then determined whether or not the input points ND2 and ND3 of the NAND gate NA3 of which the states are defined are included in the input node lists ND_IN1 to ND_IN4 at step S218.

When the input points ND2 and ND3 of the NAND gate NA3 are not included in the input node lists ND_IN1 to ND_IN4 at step S220, another element connected to the input points ND2 and ND3 of the NAND gate NA3 is traced back at step S222.

As a result, two NAND gates NA1 and NA2 are detected through the trace-back operation, and it is determined whether output points of the two NAND gates NA1 and NA2 are identical to the nodes ND2 and ND3 at step S212. Herein, to prevent elements having output points not identical to the nodes ND2 and ND3 from being traced back, the step S222 may be further performed depending on whether the output points are identical to the nodes ND2 and ND3.

The determination result proves that the output points of the two NAND gates NA1 and NA2 are identical to the nodes ND2 and ND3, and therefore, states of input points ND_IN1, ND_IN2, ND1 and ND_IN4 of the two NAND gates NA1 and NA2 are defined to satisfy the states of the nodes ND2 and ND3 at step S214. The input points ND_IN1 and ND_IN2 of the NAND gate NA1 are defined to have different logic levels because the node ND2 is in logic low level. Likewise, the input points ND1 and ND_IN4 of the NAND gate NA2 are defined to have different logic levels because the node ND3 is in logic low level.

At steps S218 and S220, it is determined whether or not the input points ND_IN1, ND_IN2, ND1 and ND_IN4 of the two NAND gates NA1 and NA2 are included in the input node lists ND_IN1 to ND_IN4. As a result, since the two input points ND_IN1 and ND_IN2 of the NAND gate NA1 and the input point ND_IN4 of the NAND gate NA2 are included in the input node lists ND_IN1 to ND_IN4, the states of the input nodes are outputted to the simulator 20 at step S224.

On the other hand, the other input point ND1 of the NAND gate NA2 is not included in the input node lists ND_IN1 to ND_IN4, and thus another element connected to the node ND1 is traced back at step S222.

An inverter INV connected to the node ND1 is detected through the trace-back operation. When it is determined at step S212 that an output point of the inverter INV is identical to the node ND1, a state of an input point ND_IN3 of the inverter INV is defined at step S214.

Since the input point ND_IN3 of the inverter INV is included in the input node lists ND_IN1 to ND_IN4, the state of the node ND_IN3 is outputted to the simulator 20 at step S224.

In conclusion, when the output node OUT has a logic high level, the two input nodes ND_IN1 and ND_IN2 are defined to have different logic levels, and the two input nodes ND_IN3 and ND_IN4 are defined to have the same logic level.

The simulator 20 creates a header file based on the states of the input nodes ND_IN1 to ND_IN4 defined by the circuit analyzer 10, and then simulates the circuit using the created header file. That is, the simulator 20 performs simulation after receiving the states of the input nodes ND_IN1 to ND_IN4 defined by the circuit analyzer 10 as input signals IN1 to IN4, which makes it possible to obtain the characteristic and waveform of an output signal OUT, which are intended by a circuit designer.

As described above, the integrated circuit verification device in accordance with the present invention creates the header file by receiving the state of the output node that is intended by a circuit designer, and then tracing back the state of the input node satisfying the state of the output node.

Accordingly, the state of the input node can be easily defined even in a complicated circuit, and a circuit designer can clearly define the state of the input node, thus obtaining an accurate simulation output waveform.

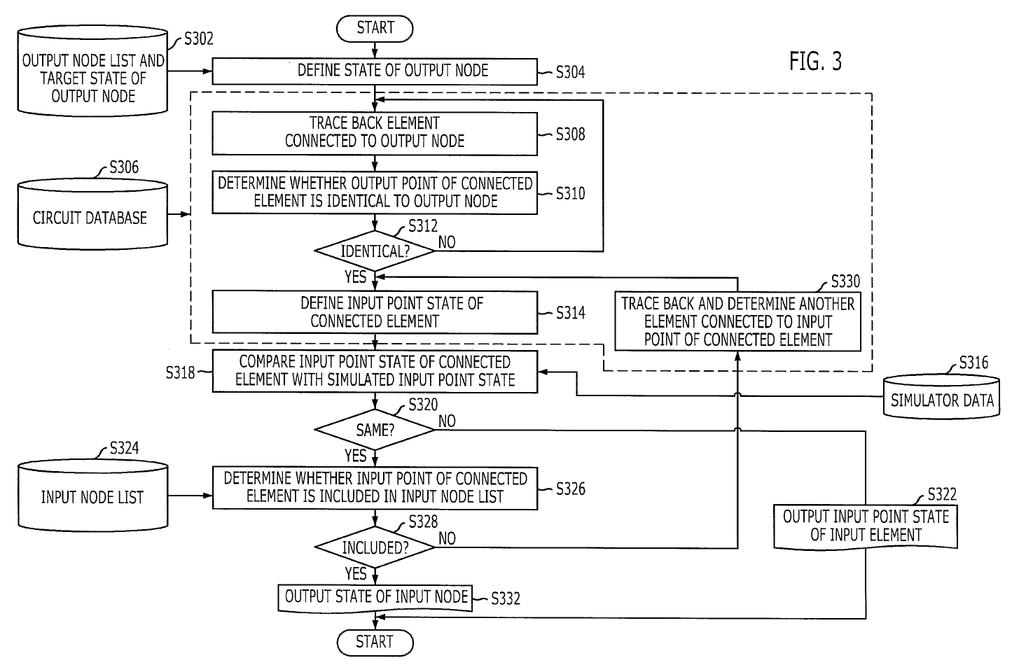

The integrated circuit verification device having the configuration of FIG. 1 may operate in accordance with another embodiment of the present invention in FIG. 3. In particular, the operation of the circuit verification device in accordance with this embodiment of FIG. 3 will be described below when a circuit to be verified has the configuration of FIG. 4.

First, the storage unit 11 stores the structure data of the circuit and the target state of the output node.

At step S302, an output node list ND_OUT and a target state of the output node, which are stored in the storage unit 11, are inputted. Then, at step S304, a state of the output node is defined. Herebelow, it is assumed that the target state of the output node ND_OUT is a logic high level.

After the state of the output node ND_OUT is defined, a circuit database stored in the storage unit 11 is inputted at step S306, and then a NAND gate NA3 connected to the output node ND_OUT among elements NA1, NA2, NA3 and INV is traced back at step S308.

At step S310, it is determined whether an output point of the NAND gate NA3 is identical to the output node ND_OUT. When it is determined at step S312 that the output point of the NAND gate NA3 is identical to the output node ND_OUT, states of input points ND2 and ND3 of the NAND gate NA3 are defined to satisfy the sate of the output node ND_OUT at step S314. Since the output node ND_OUT is in a logic high level, the input points ND2 and ND3 of the NAND gate NA3 are defined to have logic low levels, respectively.

At step S316, simulator data is inputted through the simulator 20. Herein, the simulator data, which corresponds to the result achieved by simulating the circuit using an arbitrary input node state that is pre-defined by a circuit designer, contains states of all nodes in the circuit which are defined according to the simulation.

The states of the input points ND2 and ND3 of the NAND gate NA3 are compared with the states of the nodes ND2 and ND3 that are outputted from the simulator 20. When it is determined at step S320 that the states are identical, the input node list for ND_IN1 to ND_IN4 stored in the storage unit 11 is inputted at step S324. Then, at step S326, it is determined whether the input points ND2 and ND3 of the NAND gate NA3 are included in the input node list. However, when it is determined at step S320 that the states of the input points ND2 and ND3 of the NAND gate NA3 are not identical to the states of the nodes ND2 and ND3, the states of the input points ND2 and ND3 of the NAND gate NA3 are outputted to the outside at step S322.

When the states of the input points ND2 and ND3 of the NAND gate NA3 are identical to the states of the nodes ND2 and ND3 outputted from the simulator 20, it is determined at step S326 whether the input nodes ND2 and ND3 of the NAND gate NA3 are included in the input node list.

When it is determined at step S328 that the input points ND2 and ND3 of the NAND gate NA3 are not included in the input node lists ND_IN1 to ND_IN4, another element connected to the input points ND2 and ND3 of the NAND gate NA3 is traced back at step S330.

Two NAND gates NA1 and NA2 are detected through the trace-back operation, and thereafter it is determined at step S330 whether the output points of the two NAND gates NA1 and NA2 are identical to the nodes ND2 and ND3.

The determination result proves that the output points of the two NAND gates NA1 and NA2 are identical to the nodes ND2 and ND3, and therefore, states of input points ND_IN1, ND_IN2, ND1 and ND_IN4 are defined so as to satisfy the states of the nodes ND2 and ND3 at step S314. The input points ND_IN1 and ND_IN2 of the NAND gate NA1 are defined to have different logic levels because the node ND2 is in logic low level. Likewise, the input points ND1 and ND_IN4 are defined to have different logic levels because the node ND3 is in logic low level.

At step S316, the simulator data is inputted through the simulator 20. At step S318, the states of the input points ND_IN1, ND_IN2, ND1 and ND_IN4 of the two NAND gates NA1 and NA2 are compared with the states of the nodes ND_IN1, ND_IN2, ND1 and ND_IN4 which are outputted from the simulator 20. At step S326, based on this comparison result, it is determined whether the input points having the same state as the simulator data are included in the input node list. The state of the input point not identical to the simulator data is outputted to the outside at step S322.

At steps S326 and S328, it is determined whether or not the input points ND_IN1, ND_IN2, ND1 and ND_IN4 of the two NAND gates NA1 and NA2 are included in the input node lists ND_IN1 to ND_IN4. As a result, since the two input points ND_IN1 and ND_IN2 of the NAND gate NA1 and the input point ND_IN4 of the NAND gate NA2 are included in the input node lists ND_IN1 to ND_IN4, the states of the input nodes are outputted to the simulator 20 at step S332.

On the other hand, when it is determined at step S328 that the other input point ND1 of the NAND gate NA2 is not included in the input node lists ND_IN1 to ND_IN4, another element connected to the node ND1 is traced back at step S330.

An inverter INV connected to the node ND1 is detected through the trace-back operation. It is determined at step S330 that the output point of the inverter INV is identical to the node ND1, and therefore a state of an input point ND_IN3 of the inverter INV is defined at step S314.

At step S318, the state of the input point ND_IN3 of the inverter INV is compared with the state of the node ND_IN3 outputted from the simulator 20. When it is determined at step S320 that both states are identical, it is determined at step S326 whether the node ND_IN3 is included in the input node lists ND_IN1 to ND_IN4; however, when it is determined at step S320 that both states are not identical, the state of the node ND_IN3 is outputted to the outside at step S322.

Since the input point ND_IN3 of the inverter INV is included in the input node lists ND_IN1 to ND_IN4, the state of the node ND_IN3 is outputted to the simulator 20 at step S332.

As described above, the integrated circuit verification device in accordance with the present invention traces back states of nodes of the integrated circuit so as to satisfy the state of the output node that is intended by a circuit designer. Then, the state of the back-traced node is compared with a simulation result, and the state of the back-traced node is outputted to the outside when the state of the back-traced node is not identical to the simulation result.

A circuit designer can easily find out poorly designed points of the integrated circuit based on node state data outputted from the integrated circuit verification device in accordance with the present invention, and thus easily verify and modify the integrated circuit using programming information for simulation without the use of test equipment.

In accordance with the integrated circuit verification device of the present invention, a circuit designer defines a state of an output node of an integrated circuit, and states of nodes of the integrated circuit are sequentially defined in a direction from the output node to an input node so as to satisfy the defined state of the output node. Accordingly, the state of the input node of the integrated circuit can be easily defined. Also, the accurate simulation output waveform can be obtained by clearly defining the state of the input node by the circuit designer.

Furthermore, in accordance with the integrated circuit verification method of the present invention, a circuit designer defines a state of an output node of an integrated circuit, and states of nodes of the integrated circuit are sequentially defined in a direction from the output node to an input node so as to satisfy the defined state of the output node. Accordingly, the state of the input node of the integrated circuit can be easily defined. Also, the accurate simulation output waveform can be obtained by clearly defining the state of the input node by the circuit designer.

Moreover, in accordance with the integrated circuit verification device of the present invention, a circuit designer defines a state of an output node of an integrated circuit, and states of nodes of the integrated circuit are sequentially defined in a direction from the output node to an input node so as to satisfy the defined state of the output node. Then, the defined states of the nodes are compared with a pre-simulated result to output a comparison result. Consequently, it is possible to easily find out poorly designed points of the integrated circuit using the comparison result.

Also, in accordance with the integrated circuit verification method of the present invention, a circuit designer defines a state of an output node of an integrated circuit, and states of nodes of the integrated circuit are sequentially defined in a direction from the output node to an input node so as to satisfy the defined state of the output node. Then, the defined states of the nodes are compared with a pre-simulated result to output a comparison result. Consequently, it is possible to easily find out poorly designed points of the integrated circuit using the comparison result.

While the present invention has been described with respect to the specific embodiments, it will be apparent to those skilled in the art that various changes and modifications may be made without departing from the spirit and scope of the invention as defined in the following claims.

What is claimed is:

1. An integrated circuit verification device, comprising:
a trace-back unit having structure data of an integrated circuit to be verified, and configured to trace back nodes of the integrated circuit in a direction from an output node to an input node; and
a state defining unit having data with respect to a target state of the output node of the integrated circuit, and configured to sequentially define states of back-traced nodes to satisfy the target state of the output node.

2. The integrated circuit verification device of claim 1, wherein the trace-back unit is configured to perform a trace-back operation up to the input node by defining an input node of an element having the output node as an output node of another element, and detecting input nodes of next-stage elements connected to said another element.

3. The integrated circuit verification device of claim 1, further comprising a determining unit,
wherein the determining unit is configured to determine whether the nodes which are traced back in sequence by the trace-back unit are identical to the structure data of the integrated circuit, and configured to notify to the state defining unit that the back-traced node is a node of which a state is to be defined when the back-traced nodes are identical to the structure data of the integrated circuit.

4. The integrated circuit verification device of claim 1, wherein the structure data of the integrated circuit and the data with respect to the target state of the output node are configured to be transferred from the outside.

5. An integrated circuit verification device, comprising:
a circuit analyzer having structure data of an integrated circuit to be verified and data with respect to a target state of an output node of the integrated circuit, and configured to perform trace-back operation in a direction from the output node to an input node and to sequentially define nodes which are detected in sequence by the trace-back operation; and
a simulator configured to simulate the integrated circuit using a state value of the input node defined by the circuit analyzer to provide an output of the output node.

6. The integrated circuit verification device of claim 5, wherein the circuit analyzer includes:
a trace-back unit having the structure data of the integrated circuit, and configured to trace back nodes of the integrated circuit in a direction from the output node to the input node; and
a state defining unit having the data with respect to the target state of the output node of the integrated circuit, and configured to sequentially define states of back-traced nodes to satisfy the target state of the output node.

7. The integrated circuit verification device of claim 6, wherein the trace-back unit is configured to perform a trace-back operation up to the input node by defining an input node of an element having the output node as an output node of another element, and detecting input nodes of next-stage elements connected to said another element.

8. The integrated circuit verification device of claim 6, wherein the circuit analyzer further comprises a determining unit,
wherein the determining unit is configured to determine whether the nodes which are traced back in sequence by the trace-back unit are identical to the structure data of the integrated circuit, and configured to notify to the state defining unit that the back-traced node is a node of which a state is to be defined when the back-traced nodes are identical to the structure data of the integrated circuit.

9. The integrated circuit verification device of claim 5, wherein the structure data of the integrated circuit and the data with respect to the target state of the output node are configured to be transferred from the outside.

10. An integrated circuit verification device, comprising:
a simulator having structure data of an integrated circuit to be verified and initial state data of an input node of the integrated circuit, and configured to define nodes of the integrated circuit by simulating the integrated circuit using the initial state data of the input node;
a circuit analyzer having structure data of the integrated circuit and data with respect to a target state of the output node of the integrated circuit, and configured to perform a trace-back operation in a direction from the output node to an input node and to sequentially define nodes which are detected in sequence by the trace-back operation; and
a comparator configured to compare states of nodes defined by the circuit analyzer with states of nodes defined by the simulator to output a comparison result.

11. The integrated circuit verification device of claim 10, wherein the circuit analyzer includes:
a trace-back unit having the structure data of the integrated circuit, and configured to trace back nodes of the integrated circuit in a direction from the output node to the input node; and
a state defining unit having the data with respect to the target state of the output node of the integrated circuit, and configured to sequentially define states of back-traced nodes to satisfy the target state of the output node.

12. The integrated circuit verification device of claim 11, wherein the trace-back unit is configured to perform a trace-back operation up to the input node by defining an input node of an element having the output node as an output node of another element, and detecting input nodes of next-stage elements connected to said another element.

13. The integrated circuit verification device of claim 11, wherein the circuit analyzer further comprises a determining unit,
wherein the determining unit is configured to determine whether the nodes which are traced back in sequence by the trace-back unit are identical to the structure data of the integrated circuit, and configured to notify to the state defining unit that the back-traced node is a node of which a state is to be defined when the back-traced nodes are identical to the structure data of the integrated circuit.

14. The integrated circuit verification device of claim 10, wherein, on the basis of one of the nodes in the integrated circuit, the comparator is configured to output state data of the node when a state of the node defined by the circuit analyzer is not equal to a state of the node defined by the simulator.

15. The integrated circuit verification device of claim 10, wherein the structure data of the integrated circuit and the data with respect to the target state of the output node are configured to be transferred from the outside.

16. An integrated circuit verification method, comprising:
receiving structure data of an integrated circuit to be verified and a target state of an output node of the integrated circuit;
tracing back elements connected to the output node of the integrated circuit in a direction from the output node to an input node of the integrated circuit, and sequentially defining states of input nodes of back-traced elements to satisfy the target state of the output node;
defining a state of the input node of the integrated circuit to satisfy the defined states of the input nodes of the elements by tracing back the input node of the integrated circuit; and
outputting the defined state of the input node of the integrated circuit.

17. The integrated circuit verification method of claim 16, wherein the structure data of the integrated circuit includes an input node list of the integrated circuit, an output node list of the integrated circuit, and connection data between elements of the integrated circuit.

18. The integrated circuit verification method of claim 17, wherein tracing back the input node of the integrated circuit includes:
determining whether the input node of the back-traced element is included in the input node list of the integrated circuit; and
repeating tracing and determining operations on another element connected to the input node of the element when the input node of the back-traced element is not included in the input node list of the integrated circuit.

19. An integrated circuit verification method, comprising:
receiving structure data of an integrated circuit to be verified, a simulation result of the integrated circuit, and a target state of an output node of the integrated circuit;
tracing back elements connected to the output node of the integrated circuit in a direction from the output node to an input node of the integrated circuit, and sequentially defining states of input nodes of back-traced elements to satisfy the target state of the output node;
comparing the defined states of the input nodes of the elements with the simulation result, and determining whether the defined states of the input nodes of the elements are identical to the simulation result; and
outputting an input node data of the element which is not identical to the simulation result.

20. The integrated circuit verification method of claim 19, wherein:
the structure data of the integrated circuit includes an input node list of the integrated circuit, an output node list of the integrated circuit, and connection data between elements of the integrated circuit; and
the simulation result includes state values of nodes of the integrated circuit which are outputted after the integrated circuit is simulated using initial state data of the input node of the integrated circuit.

21. The integrated circuit verification method of claim 20, wherein determining whether the defined states of the input nodes of the elements are identical to the simulation result is performed by repeating operations of:
determining whether the input node of the element is included in the input node list of the integrated circuit when the state of the input node of the element is identical to the simulation result;
tracing back another element connected to the input node of the element when the input node of the element is not included in the input node list of the integrated circuit;
defining a state of an input node of said another back-traced element to satisfy the state of the input node of the element; and
comparing the state of the input node of said another element with the simulation result.

22. The integrated circuit verification method of claim 21, wherein the state of the input node of the element is outputted when the input node of the back-traced element is included in the input node list of the integrated circuit.
